(19) United States
(12) Patent Application Publication
(10) Pub. No.: US 2025/0307871 A1
(43) Pub. Date: Oct. 2, 2025

(54) GAI MODELING FOR AUDIENCE TARGETING

(71) Applicant: Microsoft Technology Licensing, LLC, Redmond, WA (US)

(72) Inventors: Jiarui Wang, San Jose, CA (US); Angelos Mavrogiannis, College Park, MD (US); Jinghui Mo, Wellesley, MA (US); Xiaochen Liu, Santa Clara, CA (US); Alice Wu, Sunnyvale, CA (US); Elizabeth Marie Gentile, New York, NY (US)

(21) Appl. No.: 18/620,490

(22) Filed: Mar. 28, 2024

(51) Int. Cl. G06Q 30/0251; G06N 3/0895; G06Q 30/0241

(52) U.S. Cl. CPC G06Q 30/0251; G06N 3/0895; G06Q 30/0277

(57) ABSTRACT

In an example embodiment, a framework is presented that utilizes a large language model (LLM) to aid in the generation of targeting criteria, namely in generating portions of information that will be used to generate a target audience for a particular media item, based in part on the media item itself. More specifically, the LLM is used to produce a suggestion of one or more facets of a target audience, wherein each facet is a category of information for users within the target audience. The LLM is then also used to produce a plurality of segments within the one or more suggested facets. The produced facets and segments may then be used to create a target audience for the media item, even in a cold-start environment where no information about a desired audience is provided by the entity wishing to distribute the media item.

### TECHNICAL FIELD

The present disclosure generally relates to technical problems encountered in machine learning. More specifically, the present disclosure relates to generative artificial intelligence (GAI) modeling for audience tracking.

### BACKGROUND

The rise of the Internet has occasioned two disparate yet related phenomena: an increase in the presence of online networks, such as social networking services, with their corresponding user profiles visible to large numbers of people, and an increase in the use of these online networking services to provide content. An example of such content is advertising content, but similar issues can arise with many different types of content. In the advertising content example, advertisements (also known as sponsored content) may be posted to a social networking service to be presented to users of the social network service, oftentimes in conjunction with non-advertisement content (also known as organic content). For example, advertisements may be interspersed in a social networking feed on the social networking service, with a feed being a series of various pieces of content presented in reverse chronological order, along with non-advertisement content such as a combination of notifications, articles, and job listings.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a block diagram illustrating a content-based auto-targeting model, in accordance with an example embodiment.

FIG. 4 is a screen capture illustrating an example of a media item from which a target audience can be produced, in accordance with an example embodiment.

FIG. 5 is a block diagram illustrating a transformer 500 in accordance with an example embodiment.

FIG. 6 is a flow diagram illustrating a method, in accordance with an example embodiment.

FIG. 7 is a block diagram illustrating a software architecture, in accordance with an example embodiment.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

Selection of an audience for a piece of content can be challenging. Creating campaigns is complex and selecting an appropriate audience can be difficult for inexperienced campaign managers. A misconfigured audience for a piece of content can negatively impact campaign performance. What is needed is a solution that recommends appropriate audience segments for a piece of content.

Technical problems are encountered with implementing such a solution, however. To the extent that machine learning has been used previously to solve similar problems, these solutions have involved the entity interested in distributing the content specifying some type of targeting criteria and the machine learning model determining the specific audience based on that specified targeting criteria, or involved the machine learning model deducing an audience based on prior behavior of the entity or other entities (e.g., which audience the entity specified for a prior piece of content). Neither of these scenarios, however, is able to handle a so-called “cold-start” scenario, where no prior entity information is available (e.g., the entity is just being onboarded now) and where no specified targeting criteria has been provided (e.g., the entity does not know what type of audience to request).

In an example embodiment, a framework is presented that utilizes a large language model (LLM) to aid in the generation of targeting criteria, namely in generating portions of information that will be used to generate a target audience for a particular media item, based in part on the media item itself. More specifically, the LLM is used to produce a suggestion of one or more facets of a target audience, wherein each facet is a category of information for users within the target audience. The LLM is then also used to produce a plurality of segments within the one or more suggested facets, wherein each segment is a particular value of the corresponding category of information for its corresponding facet. The produced facets and segments may then be used to create a target audience for the media item, even in a cold-start environment where no information about a desired audience is provided by the entity wishing to distribute the media item. This is in contrast to a warm-start environment, where actual engagement data for a piece of content is used to creating the target audience. This is also in contrast to using a single prompt to instruct the LLM to generate both the facets and the segments at the same time, which can occasionally produce inaccurate results due to conflation of the meanings of terms that appear similar in both facets and segments but whose meanings actually differ between facets and segments.

In some example embodiments, information about the content and/or information about the entity wishing to distribute the content can be used as part of this facet and segment suggestion process. The result is that it is not necessary to know any engagement data for the content beforehand, in contrast to past approaches that were more reactive in nature in that they relied upon actual engagement data in order to predict an audience for a given piece of content.

In additional example embodiments, taxonomy information can be used to further enhance the facet and segment suggestion process. This may include, for example, feeding the taxonomy into the LLM at the time of the facet and/or segment generation, and/or mapping the generated facets and/or segments to elements in the taxonomy.

### DESCRIPTION

In an example embodiment, novel machine learning techniques are used to recommend an audience (e.g., a group of users) for a particular piece of content in an online network.

In some example embodiments, the audience recommendation model may be implemented with a large “flywheel” of models. This flywheel is described in more detail below, but it generally involves a system where multiple machine learning models are trained over a shared goal. Nevertheless, nothing in this disclosure shall be taken as limiting the implementation of the audience recommendation model to be within a flywheel, unless otherwise stated. A flywheel implementation is merely one possible implementation of the audience recommendation model presented herein.

As to the flywheel, many social networking services, and online portals in general, have multiple different components that handle various elements of a piece of content's lifecycle. An advertisement, for example, may be created in one component, while an audience for the content is determined using a different component, and a bid price for the piece of content may be automatically determined using yet another component. Each of these components may utilize machine learning models to perform various tasks, but due to the separateness of these components, the machine learning models operate independently of one another, leading to various inefficiencies.

A flywheel enables end-to-end automation across many different components in an online network. End-to-end optimization is a machine-learning approach where the entire system, from input to output, is optimized as a whole, without breaking down the system into separate components for the purpose of optimization. In other words, the optimization is performed over the entire pipeline of the system, rather than optimizing each component separately. In this particular case, the end-to-end optimization may be accomplished through a combination of embedding-based retrieval, privacy-preservation modelling, multi-task learning, reinforcement learning, and generative artificial intelligence (GAI).

This optimization process allows components to interact with each other, with each component relying on some aspect of at least one other component for joint optimization. This integrated approach allows for a seamless and efficient process to optimize various online network activities, such as content and/or advertising display, geared towards a unified goal. Additionally, it creates a closed optimization cycle where each component potentially interacts with each other, with the flywheel connecting and sharing knowledge among previously isolated optimization components to improve outcomes. For example, insights from measuring qualified leads and audience signals can be used to continuously improve model performance and drive further outcome optimization.

An online network may contain various different components, each programmed to perform a different task. Some of these components may utilize one or more machine learning models in the furtherance of those tasks. These machine learning models, however, are optimized independently of one another. In other words, each model is trained independently to one another to optimize a different goal. While there have been some efforts made to train co-existing machine learning models to optimize a single goal by, for example, training those machine learning models together, such efforts have been limited to machine learning models within the same component of an online network and thus have more traditionally overlapping goals.

In some online networks, however, the components perform significantly different tasks from one another, making training co-existing machine learning models from different components technically challenging. In other words, it is difficult to optimize models located in completely distinct components and with different functionality on one or more shared goals.

For example, in an online network that hosts and presents content, including promoted (i.e., paid) content, there may be a relevance component dedicated to improving content results by adjusting bidding and delivery strategies based on aspects such as conversions and lead quality; an audience component dedicated to identifying the correct audience based on aspects such as audience expansion; a creative component dedicated to ensuring that the right message is delivered to promote engagement with the online network; and a customer experience component dedicated to streamlining a campaign management process.

Furthermore, in an example embodiment, a user need only supply a small seed of information, such as content to be distributed, and from there the end-to-end optimization flywheel is able to provide suggestions for the predicted target audience, and the bidding and delivery mechanisms by leveraging information known about the user, their prior ad campaigns, and their known products (e.g., product pages).

These disparate components may all be created and managed using artificial intelligence-driven optimizations, specifically by using one or more machine learning models to make predictions about likelihoods of certain events happening and then optimizing actions based on the goals of the components. For example, the relevance optimization model may contain a machine learning model for conversion prediction that outputs a prediction of a likelihood that presenting a paid piece of content will result in some sort of downstream benefit to the entity that paid for the piece of content to be displayed (such as a sale based on a presented advertisement, or an application for a job associated with a presented job listing). That model, however, is basically trained to optimize for conversions, which may be a different goal than, for example, a machine learning model used by the audience component, which may be trained to optimize for user engagement.

As to the audience engagement component, in an example embodiment, an LLM is used to produce both the facets for the target audience but also to provide the segments for those facets.

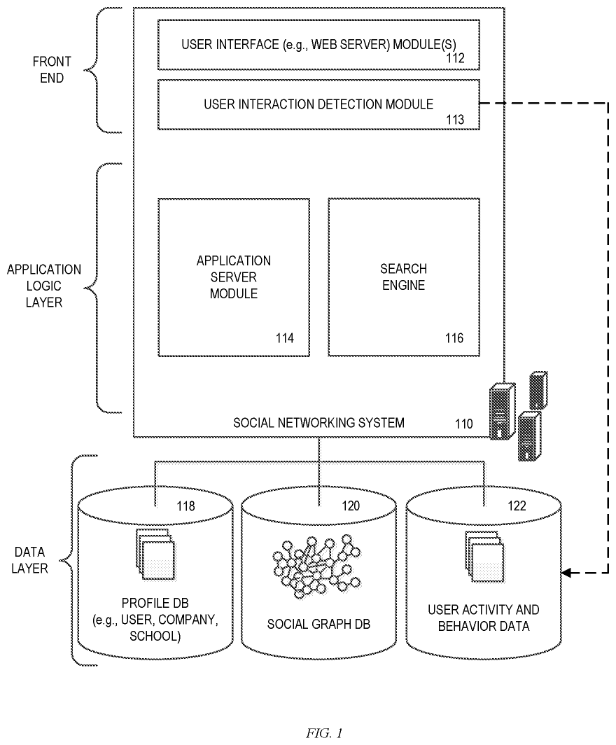

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based Application Program Interface (API) requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118 or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behaviors may be logged or stored, for example, as indicated in FIG. 1, by the user activity and behavior database 122. This logged activity information may then be used by a search engine 116 to determine search results for a search query.

Although not shown, in some embodiments, a social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

At a threshold level, the present solution provides for the connecting of isolated optimization components and the continued automation of each component through artificial intelligence technologies.

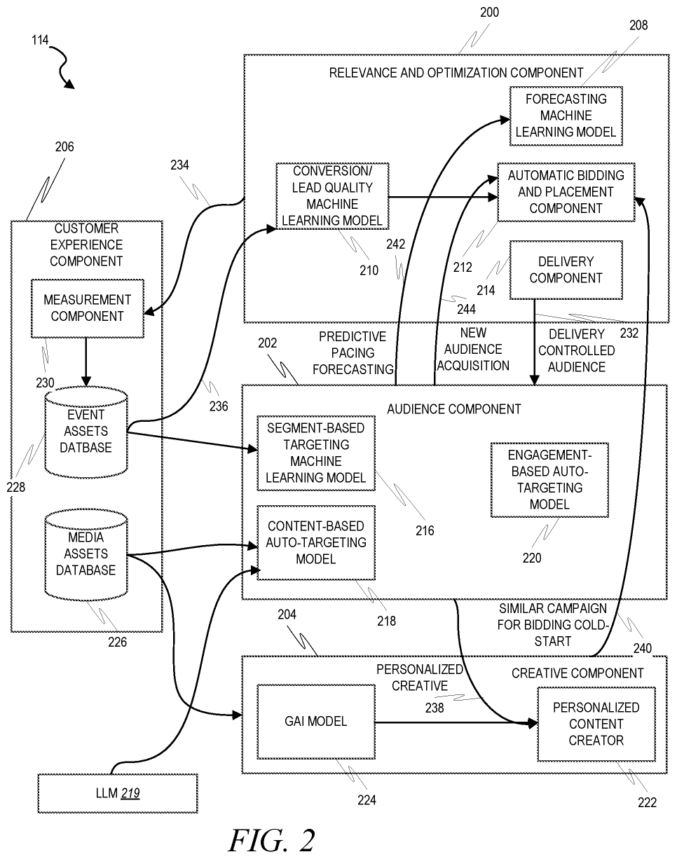

FIG. 2 is a block diagram illustrating the application server module 114 of FIG. 1 in more detail, in accordance with an example embodiment. While in many embodiments the application server module 114 will contain many subcomponents used to perform various different actions within the social networking system 110, in FIG. 1, only those components that are relevant to the present disclosure are depicted. Additionally, while a single application server module 114 is depicted here as containing many different components, in some example embodiments some or all of the different components may be located on different application server modules, and even some of the components may be located on client devices such as user devices.

Here, application server module 114 may contain a relevance and optimization component 200, an audience component 202, a creative component 204, and a customer experience component 206. It should be noted that even though this figure depicts these components as residing on a single application server module 114, in implementation, it is possible that one or more of these components may reside on different application server modules 114, potentially located at different geographical locations.

Also contained somewhere in application server module 114 will be embeddings. In some example embodiments, a repository for embeddings is maintained in the application server module 114, but in other example embodiments the embeddings are stored in other data stores. These embeddings will be described in more detail below.

The relevance and optimization component 200 improves advertising campaign results by adjusting bidding and delivery strategies. The building blocks for such goals may include, for example, conversion optimization, lead quality modeling, automatic bidding, automatic placement, dynamic margin (e.g., revenue minus costs), automatic format, dynamic group format, lifetime pacing, pacing forecast (e.g., forecast about when advertising budgets will be used up), and ads relevance. Thus, as depicted here, the relevance and optimization component 200 may include a forecasting machine learning model 208, a conversion/lead quality machine learning model 210, an automatic bidding and placement component 212, and a delivery component 214. The forecasting machine learning model 208 acts to predict future ad spending in a campaign. For example, it may utilize general predictive pacing forecasting information passed to it from the audience component 202 about the predicted pace of spending of advertisements traditionally displayed to the predicted audience and may generate a more specific pace of spending forecast for this particular advertising campaign.

The audience component 202 identifies a correct audience for content (at scale). The building blocks for this goal may include, for example, audience expansion and predictive audience (predicting an audience for content). Thus, as depicted here, the audience component 202 may include a segment-based targeting machine learning model 216, a content-based auto-targeting model 218, and an engagement-based auto-targeting model 220. The content-based auto-targeting model 218 generates a suggestion of a target audience based on the content. As will be described in more detail below, this may be accomplished via the generation of suggested facets and segments by an LLM 219. The engagement-based auto-targeting model 220 provides a prediction of which audience members to target (e.g., which users to include in the audience) based on a likelihood of each of these audience members engaging with the content. This may include using information known about audience members, such as user profiles and/or information about prior engagement by users to make these predictions.

The term “engagement” can be defined as some sort of interaction with the content. The exact form of this interaction can vary based on the type of user interface used for the engagement and how “success” is measured in the system. For example, in some scenarios, clicking on or otherwise selecting a piece of content for viewing is enough to count as engagement, but in other scenarios the engagement may be defined as some action subsequent to mere clicking on or selecting the content, such as making a purchase (where the piece of content is an advertisement for the product purchased) or applying for a job (where the piece of content is a job listing).

The creative component 204 ensures that the right message is delivered to promote engagement. The building blocks for this goal may include, for example, a personalized content creator 222 and a GAI model 224.

The customer experience component 206 streamlines the campaign management process. The building blocks for this goal may include, for example, a campaign manager, a business event manager, and an event/quality signal tracking. The customer experience component 206 may contain a media assets database 226, which supplies raw content and content-related information (such as text, video, and/or images used by the GAI model 224 to create new content in text, video, and/or video format). The GAI model 224 is capable of creating new content from scratch or capable of generating variants of existing content. In some examples, the GAI model 224 may also use existing content on the customer's product page to generate content, such as an advertisement based on the content in the customer's product page For example, contents from the customer's product page may be stored at the media assets database 226 or may be fed to the GAI model 224 directly from the customer's product page.

The customer experience component 206 may further contain an event assets database 228 that contains information relating to events that occur related to user interaction with content. More particularly, measurements, such as a measurement taken by the relevance and optimization component 200, may be obtained by a measurement component 230 and stored in the event assets database 228 to be later used by the conversion/lead quality machine learning model 210. In some examples, the measurements may include conversion rate (percentage of users who take a desired action), engagement (e.g., number of likes, comments, etc.), click-through-rate (percentage of recipients who click on the content), and time on site.

To facilitate end-to-end optimization of all of these components in FIG. 2, connections between the components may be established in a manner that allows for such cross-component optimization. Specifically, connections between certain components can themselves be trained to optimize over some goal. For example, connection 232 in FIG. 2 is between relevance and optimization component 200 and audience component 202. A goal here may be to ensure that bidding on content does not get too high for a narrow audience, which would impair conversions. Thus, if the system as a whole determines that such a goal is not being met or might not be met if certain criteria related to bidding are strictly enforced, those criteria may be relaxed to find the nearest relevant audience to expand the audience for that particular content delivery to a wide enough level to ensure that the goal is met. Connection 232 is labeled “delivery controlled audience” because the audience itself (which is determined in the audience component 202) can be adjusted based on the delivery parameters (which are determined in the relevance and optimization component 200). Training of a model for this connection 232 uses tracking data to track the delivery parameters and the audience segments being served by the delivery.

Other connections, such as connection 234 between the relevance and optimization component 200 and the customer experience component 206 may not require training a model. Here, for example, the relevance and optimization component 200 may obtain feedback from delivery providers, such as advertisers, regarding performance (such as conversion rates). This information can then be passed via connection 234 to the customer experience component 206. This information may then be aggregated by the measurement component 230 and stored in the event assets database 228. The aggregated data can then be used by the relevance and optimization component 200 via connection 236 as an input to the conversion/lead quality machine learning model 210

Another example of a connection with a model that is learned via training includes connection 238, labeled “personalized creative.” Here, based upon the targeting intent from the audience component 202, a different piece of content (e.g., ad copy) may be generated in the creative component 204 to appeal to the specific audience determined in the targeting intent.

Another example of a connection that is learned via training includes connection 240, labeled “similar campaign for bidding cold-start.” The information generated via the connection 240 involves information about what advertising campaigns might be similar to the present advertising campaign, which may be used when the user or user's company has no prior advertising campaign information to draw from (a so-called “cold-start” scenario).

Another example of a connection that is learned via training includes connection 242, labeled “predictive pacing forecasting.” The information generated via the connection 242 involves information about the pace at which advertising campaigns generally would be predicted to spend on advertising to users within a predicted audience.

Another example of a connection that is learned via training includes connection 244, labeled “new audience acquisition.” The information generated via the connection 244 involves information about a predicted audience for the content.

The result of these connections is that an end-to-end flywheel is achieved. For example, for conversion optimization, which identifies deeper conversion opportunities through enhanced bidding, end-to-end deep learning models can be implemented across multiple conversion models, such as straight conversion, lead generation, and talent lead models, which makes it possible to extend functionality to a multi-layered model structure to incorporate additional conversion signals. Furthermore, third-party conversion signals can be further leveraged in conversion optimization, such as offline conversions, customer relationship management, qualified leads, converted leaders, etc., to improve existing conversion models and build lead quality models. This provides valuable supplemental conversion signals in a privacy landscape. To achieve this, a two-layer federated learning model with privacy protection may be implemented. Additionally, a multi-task learning model may be built that differentiates leads by quality.

For delivery of content via the delivery component 214, in content marketplace optimization, bidding automation automatically adjusts bid prices in real time to improve the efficiency and effectiveness of a campaign, and budget automation allows for optimized budget allocation across different ad placements and campaigns. More particularly, reinforcement learning-based bidding algorithms can be used across multiple bidding products, such as automatic bidding, manual bidding, and cost cap bidding, and can also be extended to achieve automated delivery across other products. The bidding models can also incorporate additional signals such as audience and forecasting, as well as extending delivery automation across campaign groups.

Regarding audience, audience creation allows content providers to automatically reach the right audience at the right time with optimized campaign performance, thereby connecting members with the most relevant opportunities. Embedding-based audience creation (auto targeting) can be provided and can also be extended to create predictive audiences, which incorporates content provider signals to generate audiences for optimal outcomes. Furthermore, in some example embodiments, delivery controlled audience serving can be provided, which converts audiences into parameters for tuning campaign performance by connecting with budget delivery. To solve the cold-start problem when manual audience selection is discarded, additional signals can be incorporated from media assets, advertiser profiles, landing page content, etc., to establish content-based audience automation with a generator model and GAI.

It should also be noted that in some example embodiments a hybrid of a cold-start and a warm-start solution can be utilized, such as where the presently described cold-start solution may be used until sufficient engagement data is received for the content, at which point a warm-start solution can be utilized. In some instances this combination may not be binary. In other words, it is not necessary that either a cold-start solution or a warm-start solution be used alone, but in some instances they can be combined, such as by combining the outputs of each solution.

For the cold-start scenario, an initial audience can be generated, and a content-based GAI model 224 may be used. More specifically, given text content (creative content, landing page content, text prompts, etc.), the key facet attributes can be predicted and summarized to jump-start campaign serving. Furthermore, GAI may be leveraged to generate embeddings of the content to serve as pre-trained embeddings in a two-tower model trained using member-creative engagement data.

For creatives, creative optimization ensures that the right message is delivered to promote engagement. A personalized content creator 222 may be defined that creates a single location for uploading, managing, and selecting media for ad creation.

Referring back to the automatic bidding and placement component 212, in an example embodiment, initial prices for pieces of sponsored content, called base bids, are set based on predictions of subsequent interactions with the sponsored pieces of content and daily budgets for the sponsored pieces of content. For example, one or more machine learning models may be used to predict the number of clicks, applications, and/or other types of interactions with a sponsored piece of content over a day based on historical time-series data associated with the interactions. An initial price for the sponsored piece of content may then be calculated by dividing the sponsored piece of content's daily budget by the predicted number of interactions. In an example embodiment, this predicted number of interactions is based on a corrected version of the number of impressions from the previous day.

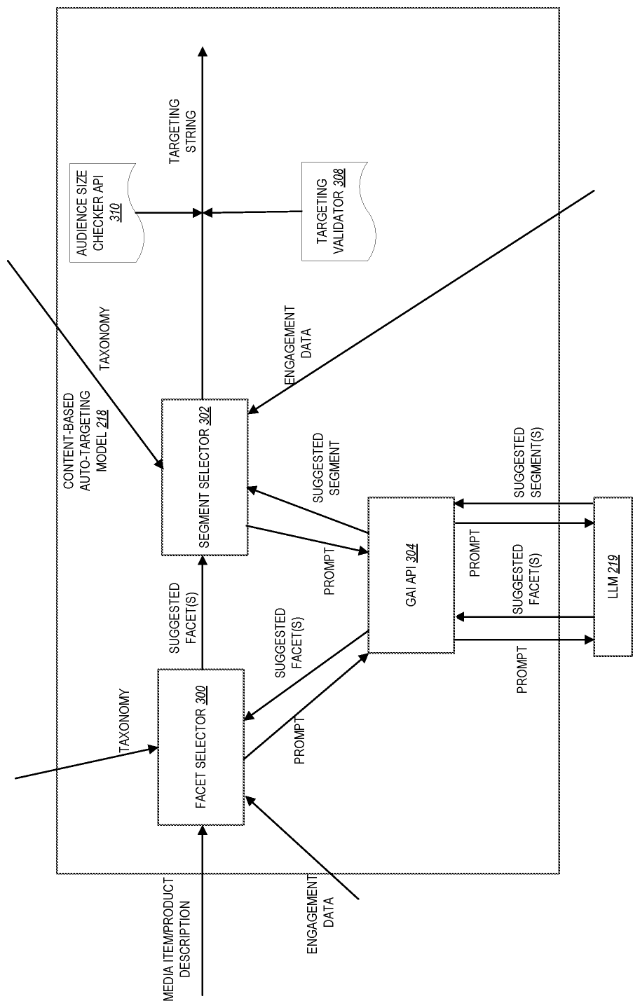

FIG. 3 is a block diagram illustrating a content-based auto-targeting model 218, in accordance with an example embodiment. Here, the content-based auto-targeting model 218 includes a facet selector 300 and a segment selector 302. Information about a media item, such as the media item itself and/or a description of the media item, may be sent to the facet selector 300. The facet selector 300 then generates a prompt for sending to a GAI application program interface (API) 304, which sends the prompt to an LLM 219. The prompt includes instructions for the LLM 219 to produce a suggestion of one or more targeting facets for the media item. This may occur in a few different ways, depending upon implementation preference. In one example embodiment, the prompt instructs the LLM 219 to select from among a predefined list of targeting facets, such as facets contained in a predefined taxonomy. The taxonomy may include a hierarchical organization, such as a tree structure, indicating names of facets/segments and the relationships among them. In such an embodiment, the prompt may therefore include the information about the media item, the predefined list of targeting facets, and the instructions to the LLM 219 to select targeting facets from the predefined list. In another example embodiment, no such predefined list of targeting facets is provided, so the prompt instructs the LLM 219 to generate the suggestion of the one or more target facets on its own.

When the suggested facet(s) are received from the LLM 219 via the GAI API 304, in some example embodiments the suggested facet(s) is/are modified prior to using them as part of the target audience creation process. This modification can take many forms, such as mapping the suggested facets to taxonomy facets, filtering the suggested facets, etc. For example, the LLM generated suggested facet of “job” might be modified to fit the taxonomy entity of “job title.” Details on these embodiments will be described in more detail below.

Regardless, once the targeting facets are actually selected, these targeting facets may be sent to the segment selector 302. The segment selector 302 then generates a prompt for sending to the GAI API 304 that includes instructions to produce a plurality of segments for the selected targeting facets. As with the targeting facets, the generating the prompt may occur in a few different ways, depending upon implementation preference. In one example embodiment, the prompt instructs the LLM 219 to select from among a predefined list of targeting segments, such as segments contained in a predefined taxonomy. Thus, for example, the LLM may be instructed to select from all the job titles in the taxonomy. In such an embodiment, the prompt may therefore include the information about the predefined list of targeting segments, and the instructions to the LLM 219 to select targeting segments from the predefined list. In another example embodiment, no such predefined list of targeting segments is provided, so the prompt instructs the LLM 219 to generate the plurality of targeting segments on its own.

Once the LLM 219 produces the plurality of targeting segments, these segments (and the suggested facet(s)) may be used to create the target audience for the media item. In some example embodiments, the target audience may be validated by a targeting validator 308, and the size of the audience can be checked via an audience size checker API 310; in any case, the target audience may be ultimately represented by a targeting string that defines the target audience for the media item. If the audience size check or validation of the target audience fail, then the entire process may be restarted and prompts generated with larger numbers of requested facets and segments.

Additionally, in some cases, negative targeting criteria and/or filters may be specified. For example, an advertiser may indicate that certain targeting segments should not be used and thus should be blocked from being used in the final targeting of the content. In these cases, the negative filters can be applied to the generated audience prior to use in causing display of the media item.

Additionally, as pictured here, in some instances engagement data may be received by the facet selector 300 and/or segment selector 302. While such engagement data typically would not be available in pure cold-start scenarios, it could be used in a hybrid cold-warm start or even a warm start scenario where facet and segment selection are at least partially based on some engagement data.

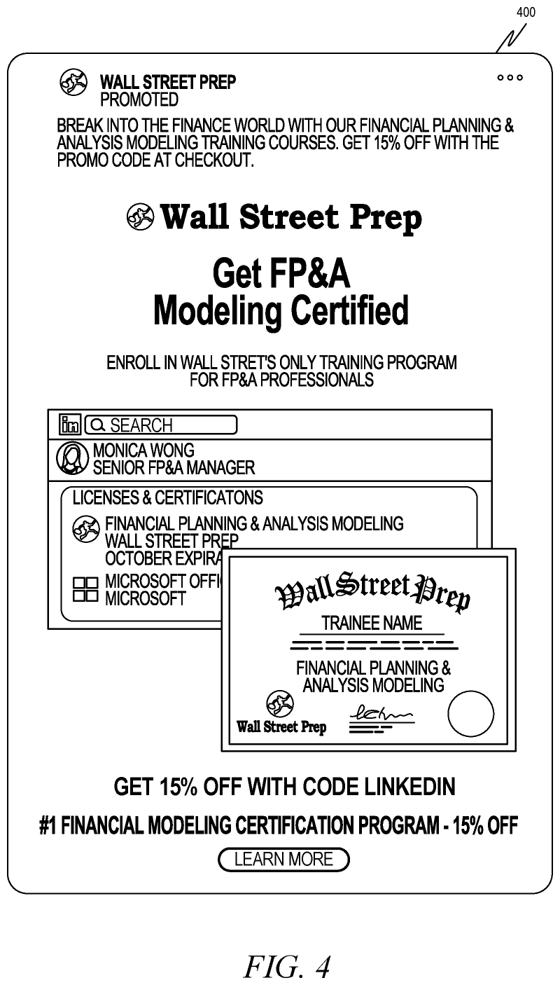

FIG. 4 is a screen capture illustrating an example of a media item 400 from which a target audience can be produced, in accordance with an example embodiment. Here the media item 400 is an advertisement that includes a text portion and an image portion (here the portions are intermixed). While this example depicts a media item having text and image portions, in other embodiments other types of portions may be included in lieu of or in addition to the text and image portions, such as a video portion.

The facet selector 300 may then generate a prompt based on some of the text portion and specified facets from a predefined list, such as the following prompt:
Given an ad context: “Break into the finance world with our financial planning & analysis modeling training courses. Get 15% off with the promo code at checkout.”
Choose 4 targeting facets for the campaign from: “Member groups, Contextual ad size, Company size, Contextual company, Member schools, Website segments, Degrees, Member age, Years of experience, Member skills, Job seniority, Member gender, Company Categories, Job Title, Contextual ad zone, Company industry, Company followers, Job function, Member Interests, Member language, Company Name, Location”. comma separate the answer

The LLM 219 may then respond with the following suggested targeting facets:
Member age, Years of Experience, Job title, Company Industry

These suggested targeting facets may then be sent to the segment selector 302, which can generate its own prompt to the LLM 219 as follows:
Given an ad context: “Break into the finance world with our financial planning & analysis modeling training courses. Get 15% off with the promo code at checkout.”
Choose 3 targeting “company industry” from these options: “Financial Services, IT Services and IT Consulting, Construction, Industrial Machinery Manufacturing, Banking, Hospitals and Health Care, Motor Vehicle Manufacturing, Retail, Pharmaceutical Manufacturing, Appliances, Electrical and Electronics Manufacturing, Software Development, Food and Beverage Manufacturing, Manufacturing, Oil and Gas, Insurance, Automation Machinery Manufacturing, Machinery Manufacturing, Transportation, Logistics, supply Chain and Storage, Investment Banking, Food and Beverage Services, Technology, Information and Internet, Investment Management, Telecommunications, Renewable Energy Semiconductor Manufacturing, Civil Engineering, Computers

The LLM 219 may then responds with the following segments, based on its understanding of the meanings of the possible segments outlined in the prompt and their similarity in meaning to the ad context:
Financial Services
Banking
Investment Banking

The result is that the second prompt was derived from the results of the first prompt, and the suggested facets and segments can be combined into a targeting string, such as, “Company Industry: Financial Services, Banking, Investment Banking.”

The information about the media item that is used by the facet selector 300 to generate the first prompt may be selected from, for example, the following:
1. Product name and product description (e.g., for the product that the media item is advertising or related to).
2. Media item text data, including commentary, headlines, video captions, etc.
3. Media item image data, including text extracted from the image.
4. Landing page data (e.g., a Uniform Resource Locator (URL) for a page to which the media item is related or links a viewer to), as well as data extracted from the page associated with the URL, such as text data scraped from the URL.

It should be noted that the LLM 219 may be able to understand multiple languages, but in some example embodiments it is beneficial to request the LLM 219 answer in a language that matches the language in which the targeting string will be generated and/or the language in which the facets and/or segments in the predefined list or taxonomy is provided.

For instances where the media item contains multiple text portions, these portions may be concatenated prior to being included in the prompt.

In some example embodiments, the facet selector 300 may further generate its prompt in such a way as to cause the LLM to return a relevance score for each suggested facet, such as creating the prompt as follows:
Given an ad context: “Break into the finance world with our financial planning & analysis modeling training courses. Get 15% off with the promo code at checkout.”
Choose top 5 relevant ads targeting facets by relevance and return with relevance score from 1-10, with explanation.
Candidates: “Member groups, Company size, Contextual company, Member schools, Degrees, Years of experience, Member skills, Job seniority, Company Categories, Job Title, Company industry, Company followers, Job function, Member Interests, Member language, Company Name, Location”.

This may result in the following response from the LLM:
This is a challenging task that requires some assumptions and judgments about the ad context and the target audience. Here is one possible way to choose the top 5 relevant ads targeting facets by relevance, with a score from 1-10 and an explanation for each:
Member skills: 10/10. This is the most relevant facet, as it allows the ad to reach people who have the skills or are interested in learning the skills related to financial planning and analysis modeling. For example, the ad could target people who have skills like Excel, SQL, Python, financial modeling, business analysis, etc.
Job function: 9/10. This is another highly relevant facet, as it allows the ad to reach people who work or aspire to work in functions that involve financial planning and analysis, such as finance, accounting, consulting, business development, etc.
Job seniority: 8/10. This is a moderately relevant facet, as it allows the ad to reach people who are at a suitable level of experience and career progression for the training courses. For example, the ad could target people who are entry-level, associate, or mid-senior level, as they may benefit the most from the courses and have the most potential to break into the finance world.
Member schools 7/10. This is a somewhat relevant facet, as it allows the ad to reach people who have attended or are attending schools that offer relevant education or credentials for the finance world. For example, the ad could target people who have degrees or certificates in finance, accounting, economics, business, etc., or who are enrolled in such programs.
Location: 6/10. This is a slightly relevant facet, as it allows the ad to reach people who are in geographic areas that have a high demand or opportunity for financial planning and analysis roles. For example, the ad could target people who are in major financial hubs, such as New York, London, Hong Kong, etc., or who are willing to relocate to such areas.

In some example embodiments, additional information may be included in the prompt to aid the LLM 219 in generation of relevant facets. This may include providing a list of frequently used facets, providing information about revenue produced by certain facets (which can be used to weight the produced facets), equity considerations (e.g., excluding gender and age as targeting facets), or other targeting exclusion rules. Additionally, an entity wishing to distribute the media item can specify whether the targeting criteria should be combined with “AND” operators or “OR” operators. Separating various facet/segment combinations with AND makes targeting more accurate but also makes the targeted audiences narrower, whereas using “OR” operators can broaden the audience pool but may end up losing targeting accuracy. Additionally, certain facets may be considered to be “must have”, such as location and/or language, and thus the LLM 219 may be instructed to take this into consideration.

For the segment selector 302, there may be different ways for prompting the LLM 219 to choose segments. As mentioned earlier, the LLM 219 can be either instructed to use segments from a predefined list or taxonomy or to generate facets on its own. In instances where it is from a predefined list or taxonomy, a distinction may be made between facets with high cardinality (e.g., a large number of possible segment values) and facets with low cardinality (e.g., a small number of possible segment values). As an example, facets having fewer than 1000 possible segment values can be considered to be low cardinality while facets having 1000 or more possible segment values can be considered to be high cardinality.

For low cardinality segments, each of the possible segments may be included in the prompt, and the LLM 219 can be instructed to choose from among them. This may not be possible with high cardinality segments due to the technical limitations of an LLM 219, which typically impose (either directly or indirectly) a maximum number of input tokens.

In scenarios where the LLM 219 is asked to generate the facets and/or segments without the use of a taxonomy, additional mechanisms may be put in place to improve the reliability of suggested facets and/or segment. More specifically, in an example embodiment, an additional machine learning model or models may be used to refine the suggested facets and/or segments. In such an example embodiment, the returned suggested facets and/or segments may first be converted to embeddings via an embedding machine learning model. An embedding is a set of coordinates in a latent n-dimensional space such that the proximity of the coordinates to other coordinates is indicative of the similarity of the information embedded to those coordinates. Thus, for example, various segments within a taxonomy may be embedded to different sets of coordinates in the latent n-dimensional space. Then a particular suggested segment may be embedded to a first set of coordinates with that same latent n-dimensional space. This allows the similarity between the particular suggested segment and one or more of the segments in the taxonomy to be determined using a geometric calculation, such as cosine similarity. Thus, for example, if the first set of coordinates is closer to a second set of coordinates than to a third set of coordinates, the suggested segment corresponding to the first set of coordinates is considered to be more similar to the segment corresponding to the second set of coordinates than it is to the segment corresponding to the third set of coordinate.

In a further example embodiment, the embedding machine learning model can be expanded to include a deep neural network that is trained to find the top K similar segments. In an example embodiment, the machine learning algorithm used to train the deep neural network may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function. The embedding machine learning model can either be incorporated into the deep neural network as an embedding layer, or may be trained and used as a separate distinct model. This use of deep neural network to determine similarity of items based on embeddings may be known as “embedding-based retrieval” (EBR). This can be performed in real time. The advantage of using real-time EBR is that, by setting a different top K (or cut-off score), the audience pool can be broadened.

Of course, it is still possible to directly compare the produced facets/segments with the entries in a taxonomy. This can be performed using string standardization methods such as stemming and/or lemmatization (for example, “Financial Analysis” can be converted to “financial analyst”).

In some example embodiments a combination of direct comparison and EBR is used, such as by using direct comparison to obtain a facet/segment that matches a taxonomy item and then using EBR to identify the top K most similar segments.

In another example embodiment, any of the above-described models, specifically the LLM, embedding model and/or deep neural network, can be retrained based on actual performance and/or feedback. This feedback may include, for example, engagement data. For example, the LLM may be retrained (or fine-tuned) based on how the resulting media item performed when presented to audience members of a generated target audience. More particularly, the generated facets and segments are used to create the target audience and then the media item is presented to users within the target audience. Interactions (e.g., clicks or other selections) between these users and the media item content can then be measured and fed back into a training process for the LLM or fine-tuned LLM, essentially acting like labels for the actual data. Thus, for example, if a media item gets a large number of clicks for a given audience, this represents positive feedback, whereas if the media item gets relatively few, or even no, clicks for a given audience, this represents negative feedback.

Furthermore, actual interaction data can also be used to present insights (such as to a campaign manager) about why a particular campaign was or was not successful.

In some example embodiments, it may be preferable to have the LLM generate the facets and the segments at the same time (i.e., in response to the same prompt). This can be termed a “one-shot” embodiment, rather than a “two-shot” embodiment where two different prompts are used (one for facet generation and one for segment generation). An example might be the following prompt: Given an ad context [AD CONTEXT], please do the following step by step and output the results stepwise:
(1) list the 5 most relevant audience facets based on the ad context, and explain the reason concisely.
(2) for each audience facet, list 3 most relevant audience segments, and explain the reason concisely.

GAI refers to a class of artificial intelligence techniques that involves training models to generate new, original data rather than simply making predictions based on existing data. These models learn the underlying patterns and structures in a given dataset and can generate new samples that are similar to the original data.

Some common examples of GAI models include Generative Adversarial Networks (GANs), Variational Autoencoders (VAEs), and autoregressive models. These models have been used in a variety of applications such as image and speech synthesis, music composition, and the creation of virtual environments and characters.

When a GAI model generates new, original data, it goes through the process of evaluating and classifying the data input to it. In an example embodiment, the product of this evaluation and classification is utilized to generate embeddings for data, rather than using the output of the GAI model directly. Thus, for example, passing a user profile from an online network to a GAI model might ordinarily result in the GAI model creating a new, original user profile that is similar to the user profile passed to it. In an example embodiment, however, the new, original user profile is either not generated or is discarded. Rather, an embedding for the user profile is generated based on the intermediate work product of the GAI model that it would produce when going through the motions of generating the new, original user profile.

More particularly, the GAI model is used to generate content understanding in the form of the embeddings, rather than (or in addition to) generating content itself.

In an example embodiment, the GAI model is implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance. Each direction has its own hidden state, and the final output is a combination of the two hidden states.

The bidirectional encoder may be implemented as a Bidirectional Long Short-Term Memory (BILSTM) or Bidirectional Encoder Representations from Transformers (BERT) model.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer-to-language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

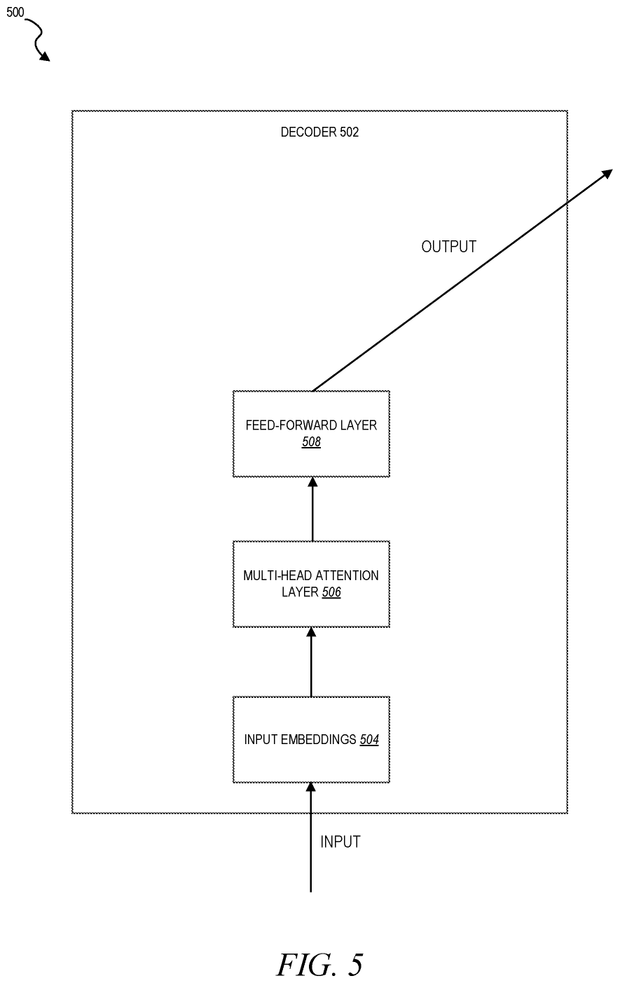

FIG. 5 is a block diagram illustrating a transformer 500 in accordance with an example embodiment. The transformer 500 includes decoder 502. Input words are transformed into input embeddings 504 that are then fed into multiple parallel self-attention heads, specifically in multi-head attention layer 506, each head captures different types of relationships and dependencies. This enhances the model's ability to understand context. Following the traversal through the multi-head attention layer 506, a feed-forward layer 508 employs one or more feed-forward neural networks characterized by multiple internal layers and non-linear activation functions. This facilitates the processing and transformation of the acquired representations, imprinted with the output highlighted by the multi-head attention layer 508, resulting on output.

In other example embodiments, a GAN embodiment may be used. GAN is a supervised machine learning model that has two sub-models: a generator model that is trained to generate new examples and a discriminator model that tries to classify examples as either real or generated. The two models are trained together in an adversarial manner (using a zero-sum game, according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, as we discussed in the previous section, although a property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a VAE model. VAEs comprise an encoder network that compresses the input data into a lower-dimensional representation, called a latent code, and a decoder network that generates new data from the latent code.

In either case, the GAI model contains a generative classifier, which can be implemented as, for example, a naïve Bayes classifier. It is the output of this generative classifier that can be leveraged to obtain embeddings, which can then be used as input to a separately trained machine learning model.

An LLM is a GAI model specifically trained to use natural language processing to handle language-related tasks.

Prompts to the LLM may be generated in a number of different ways. Zero-shot prompting involves asking the LLM to complete a task with instructions. The examples provided earlier, even those that include the taxonomy categories in the prompt, are considered to be examples of zero-shot prompting.

Few-shot prompting means that the LLM is guided by providing some question and answer examples with a final question provided to the LLM at the end of the prompt, such as:
Request: given an ads context, return 5 ads targeting facets, 10 targeting segments for each facet. Facets to choose from: Member groups, Contextual ad size, Contextual company, Member schools, Degrees, Years of experience, Member skills, Job seniority, Company Categories, Job title, Contextual ad zone, Company industry, Company followers, Job function, Member Interests, Member language, Company Name, Location
Ads context: “Working with Kafka Data in Real-Time. Join Our Free On-Demand Webinar”
Ads Targeting: “Member skills: kafka, java, python, . . . ; Job title: data engineer, software engineer
Ads context: “A better website experience leads to improved visitor engagement. Get the top ten tips for building a better experience to boost conversion and customer loyalty.”
Ads targeting: “Job title: UI designer, software engineer, Company industry, Information Technology”
Ads context: “We surveyed more than 1,600 executives and ML practitioners to uncover what's working. Here's what we found:” Ads targeting:

The LLM may then produce the following in response to this prompt:
Some possible ads targeting facets and segments for the third ads context are:
   Member interests: Data Analysis, Machine Learning, Artificial Intelligence, Data Visualization, Data Engineering, Business Intelligence, Data Science, Big Data, Deep Learning, Natural Language Processing Job function: Data Science, Machine Learning, Artificial Intelligence, Analytics, Engineering, Research, IT, Management, Consulting, Education Company size: Medium, Large, Enterprise, Startup, Small, Growth, Scale-up, Unicorn, Public, Private
Company Industry: Information Technology, Software, Internet, Computer Hardware, E-commerce, Education, Healthcare, Finance, Media, Telecommunications.
Contextual ad size: Leaderboard, Medium Rectangle, Skyscraper, Half Page, Large Rectangle, Mobile Banner, Responsive, Native, Video, Interstitial.

Additionally, as described earlier, fine-tuning the LLM is also a possibility. Fine-tuning allows for more application-specific examples than few-shot prompting, making the language model fit better into the domain at issue. This may include fine-tuning the LLM using prior media items and training features with prior targeting facets and segments as the training labels.

In an example embodiment, one or more prompt templates may be used. These templates may be created based on a series of general criteria, such as:
1. Including different types of available information. This may include having the prompt include different types of information if possible, such as including product names and descriptions in addition to media item text.
2. Providing clear instructions on an output format. This may include, for example, explicitly asking the LLM to return the result in comma-delimited format, or having a set number of choices, or output with relevance scores. This may also include specifying a language for the output (e.g., English).
3. Externally Understandable Language. This may include using text input that is easier for LLM understanding. For example, a more language-friendly “Company Size” may be used instead of “staffCountRanges.”
4. Avoid verbose answers. This may include providing examples or asking the LLM to choose from particular options to avoid overly verbose suggestions.

In some example embodiments, multiple iterations of fine tuning can be performed.

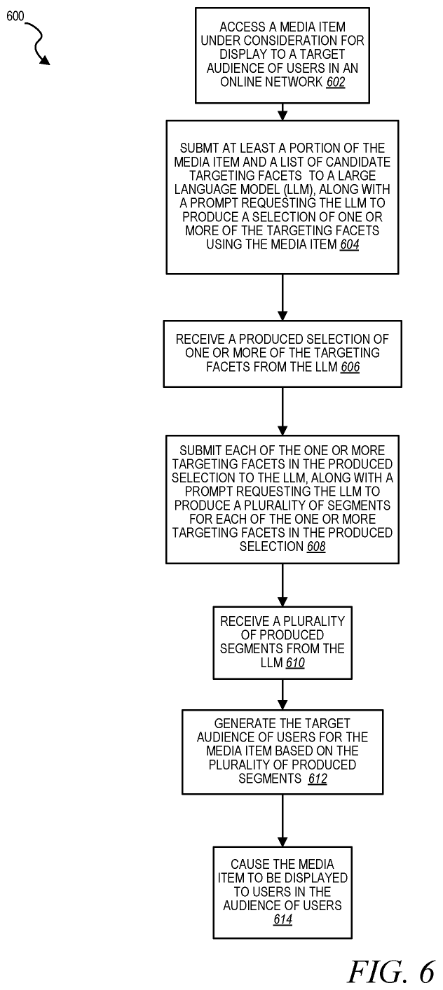

FIG. 6 is a flow diagram illustrating a method 600, in accordance with an example embodiment. At operation 602, a media item under consideration for display to a target audience of users in an online network is accessed. At operation 604, at least a portion of the media item and a list of candidate targeting facets are submitted to a large language model (LLM), along with a prompt requesting the LLM to produce a selection of one or more of the targeting facets using the media item. Each targeting facet is a category of information of the users.

At operation 606, a produced selection of one or more of the targeting facets is received from the LLM. At operation 608, each of the one or more targeting facets in the produced selection is submitted to the LLM, along with a prompt requesting the LLM to produce a plurality of segments for each of the one or more targeting facets in the produced selection. Each segment is a different entity value for a corresponding targeting facet;

At operation 610, a plurality of produced segments are received from the LLM. At operation 612, the target audience of users for the media item is generated based on the plurality of produced segments. At operation 614, the media item is caused to be displayed to users in the audience of users.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the different platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, users' personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used, and users are provided controls to opt out from their data being used for training AI models.

According to some embodiments, tools are used with the techniques described herein to identify and mitigate risks associated with AI in all products and AI systems. In some embodiments, notices may be provided to users when AI tools are being used to provide features.

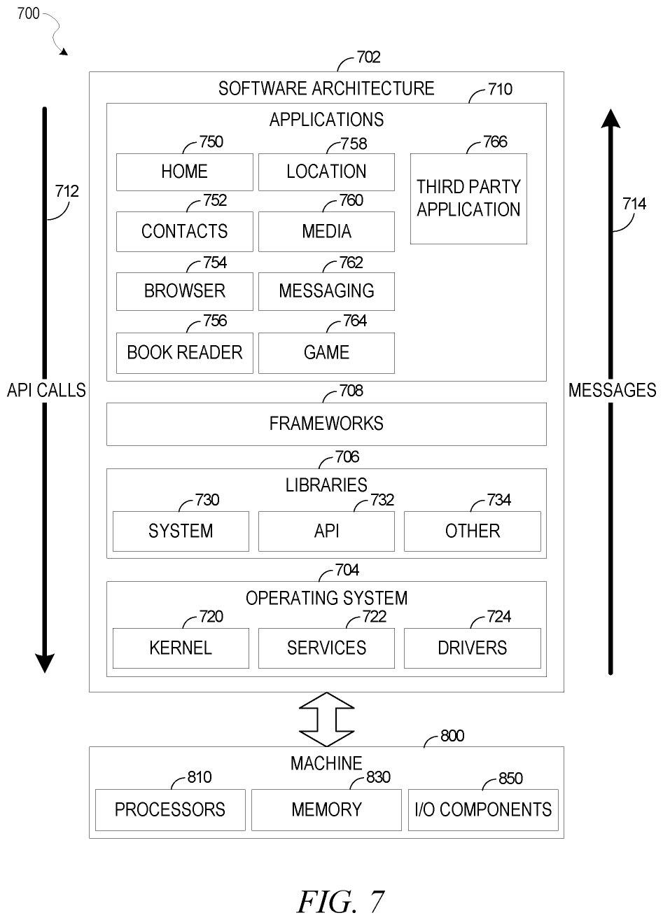

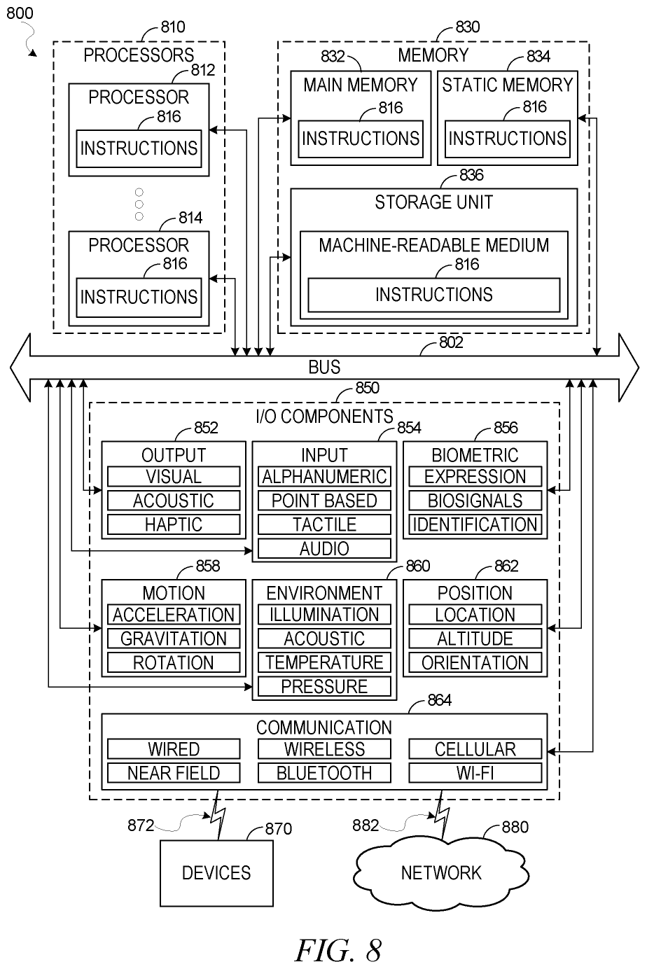

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionalities. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphical user interface functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application 710, an applet, an app, or other executable code) for causing the machine 800 to perform any one or more of the methodologies discussed herein may be executed. For example, the instructions 816 may cause the machine 800 to execute the method 600 of FIG. 6. Additionally, or alternatively, the instructions 816 may implement FIGS. 1-5, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors 812 (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor), multiple processors 810 with a single core, multiple processors 810 with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine 800 will depend on the type of machine 800. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to the processors 810. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 816 may be transmitted or received over the network 880 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one processor;
a non-transitory computer-readable medium having instructions stored thereon, which, when executed by the at least one processor, cause the system to perform operations comprising:
accessing a media item under consideration for display to a target audience of users in an online network;
submitting at least a portion of the media item and a list of candidate targeting facets to a large language model (LLM), along with a prompt requesting the LLM to produce a selection of one or more of the targeting facets using the media item, each targeting facet being a category of information of the users;
receiving a produced selection of one or more of the targeting facets from the LLM;
submitting each of the one or more targeting facets in the produced selection to the LLM, along with a prompt requesting the LLM to produce a plurality of segments for each of the one or more targeting facets in the produced selection, each segment being a different entity value for a corresponding targeting facet;
receiving a plurality of produced segments from the LLM;
generating the target audience of users for the media item based on the plurality of produced segments; and
causing the media item to be displayed to users in the target audience of users.

2. The system of claim 1, wherein the operations further comprise:
for each produced segment in the plurality of produced segments:
attempting to map the corresponding produced segment to a value in a category in a predetermined taxonomy;
in response to a determination that the attempt to map the corresponding produced segment to the value in the category in the predetermined taxonomy has failed, resubmitting the targeting facet corresponding to the corresponding produced segment to the LLM, along with a request to reproduce the plurality of segments for each of the one or more targeting facets in the produced selection; and
wherein the generating the target audience includes generating an audience of users for the media item based on mapped values in the predetermined taxonomy.

3. The system of claim 2, wherein the attempting to map includes using lemmatization on the corresponding produced segment and performing a look-ahead search using the lemmatized produced segment.

4. The system of claim 1, wherein the operations further comprise:
determining that a first targeting facet has low cardinality; and
in response to the determination that the first targeting facet has low cardinality, prompting the LLM to choose from available segments in the first targeting facet.

5. The system of claim 1, wherein the media item includes at least one of text content, image content, video content, or any combination of text content, image content, or video content.

6. The system of claim 1, wherein the operations further comprise:
collecting engagement data regarding engagement of users in the target audience with the media item; and
fine-tuning the LLM using the collected engagement data.

7. The system of claim 1, wherein the submitting at least a portion of the media item further includes submitting a taxonomy of facets to the LLM, and wherein the LLM uses the taxonomy of facets in producing the selection of one or more targeting facets.

8. The system of claim 1, wherein the submitting each of the one or more targeting facets further includes submitting a taxonomy of facets and segments to the LLM, and wherein the LLM uses the taxonomy of facets and segments in producing the plurality of segments.

9. The system of claim 1, wherein the operations further comprise:
passing the plurality of produced segments through an embedding machine learning model to generate, for each of the plurality of produced segments, an embedding indicative of a set of coordinates in a latent n-dimensional space; and
comparing the embeddings of the plurality of produced segments to embeddings of segments within a taxonomy to identify segments within the taxonomy that are closest to the plurality of produced segments.

10. The system of claim 9, wherein the comparing includes inputting the embeddings for the plurality of produced segments into a deep neural network trained to match the plurality of produced segments with a k-nearest segments in the taxonomy.

11. The system of claim 1, wherein the operations further comprise fine-tuning the LLM based on a plurality of previously targeted media items and labels generated from taxonomy facets and segments corresponding to the previously targeted media items.

12. The system of claim 1, wherein the operations further comprise using negative filters on the plurality of produced segments to eliminate one or more segments from inclusion in the target audience.

13. A method comprising:
accessing a media item under consideration for display to a target audience of users in an online network;
submitting at least a portion of the media item and a list of candidate targeting facets to a large language model (LLM), along with a prompt requesting the LLM to produce a selection of one or more of the targeting facets using the media item, each targeting facet being a category of information of the users;
receiving a produced selection of one or more of the targeting facets from the LLM;
submitting each of the one or more targeting facets in the produced selection to the LLM, along with a prompt requesting the LLM to produce a plurality of segments for each of the one or more targeting facets in the produced selection, each segment being a different entity value for a corresponding targeting facet;
receiving a plurality of produced segments from the LLM;
generating the target audience of users for the media item based on the plurality of produced segments; and
causing the media item to be displayed to users in the target audience of users.

14. The method of claim 13, further comprising:
for each produced segment in the plurality of produced segments:
attempting to map the corresponding produced segment to a value in a category in a predetermined taxonomy;
in response to a determination that the attempt to map the corresponding produced segment to the value in the category in the predetermined taxonomy has failed, resubmitting the targeting facet corresponding to the corresponding produced segment to the LLM, along with a request to reproduce the plurality of segments for each of the one or more targeting facets in the produced selection; and
wherein the generating the target audience includes generating an audience of users for the media item based on mapped values in the predetermined taxonomy.

15. The method of claim 13, further comprising:
determining that a first targeting facet has low cardinality; and
in response to the determination that the first targeting facet has low cardinality, prompting the LLM to choose from available segments in the first targeting facet.

16. The method of claim 13, further comprising:
collecting engagement data regarding engagement of users in the target audience with the media item; and
fine-tuning the LLM using the collected engagement data.

17. The method of claim 13, wherein the submitting at least a portion of the media item further includes submitting a taxonomy of facets to the LLM, and wherein the LLM uses the taxonomy of facets in producing the selection of one or more targeting facets.

18. A non-transitory machine-readable storage medium comprising instructions which, when implemented by one or more machines, cause the one or more machines to perform operations comprising:
accessing a media item under consideration for display to a target audience of users in an online network;
submitting at least a portion of the media item and a list of candidate targeting facets to a large language model (LLM), along with a prompt requesting the LLM to produce a selection of one or more of the targeting facets using the media item, each targeting facet being a category of information of the users;
receiving a produced selection of one or more of the targeting facets from the LLM;
submitting each of the one or more targeting facets in the produced selection to the LLM, along with a prompt requesting the LLM to produce a plurality of segments for each of the one or more targeting facets in the produced selection, each segment being a different entity value for a corresponding targeting facet;
receiving a plurality of produced segments from the LLM;
generating the target audience of users for the media item based on the plurality of produced segments; and
causing the media item to be displayed to users in the target audience of users.

19. The non-transitory machine-readable storage medium of claim 18, wherein the operations further comprise:
for each produced segment in the plurality of produced segments:
attempting to map the corresponding produced segment to a value in a category in a predetermined taxonomy;
in response to a determination that the attempt to map the corresponding produced segment to the value in the category in the predetermined taxonomy has failed, resubmitting the targeting facet corresponding to the corresponding produced segment to the LLM, along with a request to reproduce the plurality of segments for each of the one or more targeting facets in the produced selection; and
wherein the generating the target audience includes generating an audience of users for the media item based on mapped values in the predetermined taxonomy.

20. The non-transitory machine-readable storage medium of claim 18, wherein the operations further comprise:
determining that a first targeting facet has low cardinality; and
in response to the determination that the first targeting facet has low cardinality, prompting the LLM to choose from available segments in the first targeting facet.
